(19) United States
(12) Patent Application Publication
(10) Pub. No.: US 2021/0192477 A1
(43) Pub. Date: Jun. 24, 2021

(54) APP-LESS RESTAURANT PROCESSING SYSTEM USING MOBILE DEVICES AND OFFERING CHECK SPLITTING

(71) Applicant: UP N' GO, San Diego, CA (US)

(72) Inventor: Touradj Barman, San Diego, CA (US)

(21) Appl. No.: 17/134,059

(22) Filed: Dec. 24, 2020

Related U.S. Application Data
(60) Provisional application No. 62/953,312, filed on Dec. 24, 2019.

(51) Int. Cl. G06Q 20/10; G06Q 20/20; G06Q 20/32; G06Q 30/06; G06F 16/954; G06Q 50/12

(52) U.S. Cl. CPC G06Q 20/102; G06Q 20/20; G06Q 50/12; G06Q 30/0633; G06F 16/954; G06Q 20/3223

(57) ABSTRACT

Systems and methods are disclosed to retrieve, display, perform calculations on, and/or pay a check or other amount payable, including itemization, inside or outside of a restaurant or other venue. Some embodiments include a method comprising: receiving at a remote payment server a webpage request from a first guest mobile device, the webpage request including check data that specifies a specific check at a specific restaurant; retrieving a listing of items ordered and a cost for each item ordered based on the check data; providing an interactive webpage to the first guest mobile device, the interactive webpage includes a listing of items ordered and the cost of the items ordered; and receiving an indication from the first guest mobile device that indicates a first subset of the listing of items selected by the first guest and paid for by the first guest.

### SUMMARY

Systems and methods are disclosed for matching a guest device with a table; retrieving and presenting a unique webpage with a check associated with items ordered at the table; calculating taxes, tip and/or an total check amount or a partial check amount; and/or receiving payment for the check.

Some embodiments include systems and methods for receiving a request for a check from a mobile device; identifying the location of the mobile device within a restaurant; associating the location of a mobile device with a restaurant table; determining one or more menu items ordered at the restaurant table; calculating a total check amount based on the one or more menu items ordered; calculating taxes owed based on the one or more menu items ordered; creating a unique webpage with the one or more menu items, the sales price of the one or more menu items, the taxes owed, and the total check amount, the unique webpage including a payment method; and/or receiving payment information from the mobile device for at least a subset of the one or more menu items.

Systems and methods are disclosed to retrieve, display, perform calculations on, and/or pay a check or other amount payable, including itemization, inside or outside of a restaurant or other venue. Some embodiments include a method comprising: receiving at a remote payment server a webpage request from a first guest mobile device, the webpage request including check data that specifies a specific check at a specific restaurant; retrieving a listing of items ordered and a cost for each item ordered based on the check data; providing an interactive webpage to the first guest mobile device, the interactive webpage includes a listing of items ordered and the cost of the items ordered; and receiving an indication from the first guest mobile device that indicates a first subset of the listing of items selected by the first guest and paid for by the first guest.

In some embodiments, the interactive webpage calculates and displays a total amount due that is calculated from the first subset of the listing of items. In some embodiments, the interactive webpage calculates and displays taxes due calculated from the first subset of the listing of items. In some embodiments, the interactive webpage includes a data entry portion that allows the first guest to provide a tip amount. In some embodiments, the interactive webpage includes one or more proposed tip amounts based on one or more percentages of the total amount of first subset of the listing of items. In some embodiments, the interactive webpage includes graphics associated with the specific restaurant, server name, check adjustments, order adjustments, etc.

In some embodiments, the method further comprises: receiving a webpage request from a second guest mobile device, the webpage request including the check data that specifies the specific check at the specific restaurant; retrieving the listing of items ordered and the cost for each item ordered based on the check data; providing an interactive webpage to the second guest mobile device that lists the listing of items ordered and the cost including an indication that the first subset of the listing of items have been paid for; and receiving an indication from the second guest mobile device that indicates a second subset of the listing of items selected by the second guest and paid for by the second guest.

In some embodiments, the interactive webpage provides an indication that the first subset of the listing of items has been paid for. In some embodiments, the indication that the first subset of items has been paid for includes displaying the first subset of the listing of items in a different font, displaying the first subset of the listing of items in a different color, displaying the first subset of the listing of items in a different transparency, displaying the first subset of the listing of items without a check box or radial button, displaying the first subset of the listing of items with a strikethrough, displaying the first subset of the listing of items with the name of the first individual, and/or displaying the first subset of the listing of items in a different section than the other remaining items.

In some embodiments, the interactive webpage calculates and displays a total amount due that is calculated from the second subset of the listing of items. In some embodiments, the interactive webpage calculates and displays taxes due calculated from the second subset of the listing of items. In some embodiments, the interactive webpage includes a data entry portion that allows the second guest to provide a tip amount. In some embodiments, the interactive webpage includes one or more proposed tip amounts based on one or more percentages of the total amount of second subset of the listing of items.

### BRIEF DESCRIPTION OF THE FIGURES

These and other features, aspects, and advantages of the present disclosure are better understood when the following Detailed Description is read with reference to the accompanying drawings.

FIG. 1 is a block diagram of an example restaurant processing system according to some embodiments.

FIG. 2 is a block diagram of an example restaurant processing system according to some embodiments.

FIG. 3 is a block diagram of an example restaurant processing system according to some embodiments.

FIG. 4 is a block diagram of an example restaurant processing system according to some embodiments.

FIG. 5 is a flowchart of a process for splitting a check at a restaurant according to some embodiments.

FIG. 6 is a block diagram of a computational system for performing functionality to facilitate implementation of embodiments described herein.

### DETAILED DESCRIPTION

Systems and methods are disclosed to retrieve, display, perform calculations on, and/or pay a check or other amount payable, including itemization, inside or outside of a restaurant or other venue. In some embodiments, a mobile payment server may be used as an intermediary between a restaurant point of sale (POS) system and guest's mobile devices. The mobile payment server in response to receiving data from a guest vie a web browser, may retrieve items for payment and provide these items to the guest via a webpage.

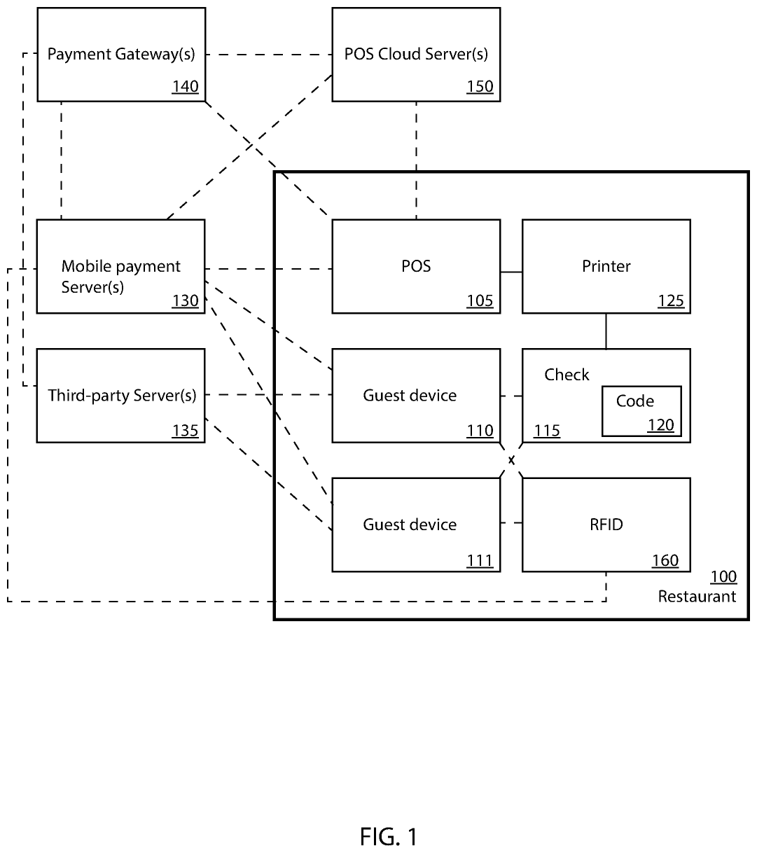

A restaurant (e.g., restaurant 100 in FIG. 1) may include one or more restaurants or other venue(s) or business(es) or entity(ies) that collects payments in exchange for goods and/or services and/or anything else.

A POS system (e.g., POS 105 in FIG. 1) may include any system that contains or has access to a check, invoice, or other record for one or more amounts due in exchange for goods or services. A POA, for example, may receive or assist in receiving payments, or note payments received elsewhere, all in full or in part. A POS, for example, may located on and/or off site relative to a restaurant. For example, a POS may be located physically at a restaurant, in the cloud, or some combination of the two.

A smartphone (e.g., guest device 110 or guest device 111 in FIG. 1) may be a smartphone, tablet, watch, or other mobile computing device that may be used to identify, retrieve and present a check, calculate an amount to pay towards a check, and/or assist in submitting a payment towards that check. The smartphone may provide other services related to the check 115.

A code (or symbol or other Identifying element) (e.g., code 120 in FIG. 1) may include a QR code, symbol, character(s), image or other recognizable visual, text, or a radio-based identifier such as, for example, an RFID code.

A check (or check data) may include a check, tab, invoice or other form of an amount due. A check, for example, may be printed on paper or other medium by a printer. Alternatively or addition, a check 115 may be a digital check that includes items, amounts, graphics, etc. A check, for example, may include itemization of elements, their prices, their quantities, adjustments such as modifications or upcharges, prices if applicable for any of those. A check, for example, may include any amount or combination of subtotals, surcharges, taxes, discounts, tips, pre-paid amounts, coupon amounts, or other amounts that sum to equate to the amount due.

A guest may include a person or entity such as a guest or customer who wants to pay part, all or more of a check. The guest may have a name, phone number, email address, or identifier associated with them.

A mobile payment server (e.g., the mobile payment server 130 server) may refer to a system that intermediates between a POS and Smartphone to complete various processes described in this document such as, for example, payment processes. A mobile payment server may include one or more server(s) that may be located locally at the restaurant and/or distributed remote relative to the restaurant.

An enhancement may refer to any information not in the POS that is added to the check or a presentation of the check by the mobile payment server (e.g., the mobile payment server 130).

FIG. 1 is a block diagram of an example restaurant processing system according to some embodiments. The restaurant 100 may include a POS 105 coupled with a printer 125. The POS 105 may be in communication with a POS cloud server 150 via the Internet or other communication system. In some embodiments, the POS cloud server 150 may be associated with a plurality of different restaurants. In some embodiments, the POS cloud server 150 may be associated with one specific restaurant. In some embodiments, the POS cloud sever 800 may be associated with a plurality of affiliate restaurants such as, for example, a chain of restaurants, restaurants that share a common owner, restaurants that are part of the same franchise, etc. The POS 105 may also be in communication with a mobile payment server 130 (e.g., the mobile payment server 130 server). The mobile payment server 130 may be in communication with one or more third-party servers 135 and/or the POS cloud server 150. A payment gateway 140 may be in communication with the POS 105, the POS cloud server 150, the mobile payment server 130, the third party servers 135, and/or various user devices (e.g., guest device 110 and/or guest device 111).

In some embodiments, the mobile payment server 130 may include some or all the components of computational system 600.

In some embodiments, a number of guests may dine together at a table at the restaurant 100. Each of the number of guests may order one or more items such as, for example, drinks, appetizers, entrees, desserts, etc. Each time the waitperson takes an order for an item, the waitperson may enter the item into the POS 105. Each item may be entered into the POS 105 as being associated with a specific table and/or the specific waitperson. The POS 105 may communicate each item to the POS cloud server 150 in association with the specific restaurant the specific table at the restaurant and/or the specific waitperson.

When the guests have concluded their meal, a check will be provided. The POS 105 may prepare a check in response to a request from the waitperson. The check may be associated with a specific check number. The check may also be provided with a unique check identifier that may include reference to the restaurant and/or the table and/or the waitperson.

In some embodiments, the check may be printed by the POS 105 using the printer 125. The printer 125 may print a code 120 (e.g., a QR code or any other type of code). The code 120 may reference a specific URL that may be used to retrieve a specific check and/or a specific restaurant and/or a specific waitperson and/or a specific table associated with the guests. The code 120, when read or scanned by a guest device 110 (e.g., a smart phone) may open a web browser or another application which may request a webpage based on the URL associated with the QR code.

The URL may be sent from the guest device 110 to the third party server 135, which may request a webpage from the mobile payment server 130 using the URL associated with the QR code. In response, the mobile payment server 130 may request information regarding the check from the POS cloud server 150 and/or the POS 105. For example, the mobile payment server 130 may send a request that includes the check number, a restaurant identifier, a table identifier, and/or a waitperson identifier.

In some embodiments, the mobile payment server 130 may identify the specific restaurant 100 based on the information provided by the URL and may request information from the restaurant POS 105 (or restaurant cloud server) based on the check number, the waitperson identifier, and/or the table identifier.

In response, to the request to the POS 105 or the POS cloud server 150, the mobile payment server 130 may receive a list of the specific items and the price for each item ordered by guests at the specific restaurant at the specific table. In some embodiments, the mobile payment server 130 may also receive restaurant enhancements.

The mobile payment server 130 may create a webpage that includes a listing of the items ordered and the price. The webpage may also include one or more restaurant enhancements.

In some embodiments, a first guest with guest device 110 may scan the code 120 (or some other method/system that allows the first guest to access the check data on their mobile device) that is associated with the guests' check and request the webpage on a mobile device. In response the mobile payment server 130 may create a webpage listing the specific items ordered at the table associated with the check. The webpage may allow the first guest to select items the first guest wishes to pay for. The webpage, for example, may automatically calculate a total for the first guest based on the first subset of items selected by the first guest. The webpage may also include a calculated tip based on a percentage of the total of the items selected by the first guest and/or a tax amount based on the total of the items selected by the first guest. The webpage may then provide a payment section that allows the first guest to pay for the selected items, a tip, and/or the tax. The mobile payment server 130 may receive an indication that the first guest has paid for the first subset of the items.

In some embodiments, a second guest with the guest device 111 may scan the code 120 and request the webpage on the guest device 111. The mobile payment server 130 may create a webpage listing the specific items ordered at the table. In this presentation of the webpage, for example, the first subset of items may not be selectable by the second guest because the first subset of items were paid for by the first guest. For example, the first subset of items may be shown, but there may not be a box or dial next to these items allowing the second guest to select them. As another example, the first subset of items may be shown, but these items may be presented in a different color, with a different font, and/or shown with an indication that these items have already been paid for. As another example, the first subset of items may not be displayed. The webpage may allow the second guest to select items other than the first subset of items that the second guest wishes to pay for. The webpage, for example, may automatically calculate a total for the second guest based on the second subset of items selected by the second guest. The webpage may also include a calculated tip based on a percentage of the total of the items selected by the second guest and/or a tax amount based on the total of the items selected by the second guest. The webpage may then provide a payment section that allows the second guest to pay for the second subset of the items, a tip, and/or the tax. The mobile payment server 130 may receive an indication that the second guest has paid for a second subset of the items.

In some embodiments, a third guest may scan the code 120 and request the webpage. The mobile payment server 130 may create a webpage listing the specific items ordered at the table. In this presentation of the webpage, the first subset of items and/or the second subset of items may not be selectable by the third guest. For example, the first subset of items and/or the second subset of items may be shown, but there may not be a box or dial next to these items allowing the third guest to select them. As another example, the first subset of items and/or the second subset of items may be shown, but these items may be presented in a different color, with a different font, and/or shown with an indication that these items have already been paid for. As another example, the first subset of items and/or the second subset of items may not be shown. The webpage may allow the third guest to select items other than the first subset of items and/or the second subset of items that the third guest wishes to pay for. The webpage, for example, may automatically calculate a total for the third guest based on the third subset of items selected by the third guest. The webpage may also include a calculated tip based on a percentage of the total of the items selected by the third guest and/or a tax amount based on the total of the items selected by the third guest. The webpage may then provide a payment section that allows the third guest to pay for the third subset of the items, a tip, and/or the tax. The mobile payment server 130 may receive an indication that the third guest has paid for a third subset of the items.

In some embodiments, the webpage provided by the mobile payment server may allow a guest to selected and/or organize items in any number of ways. For example, a guest may simply select buttons indicating that the guest is responsible for paying for the associated item. As another example, a guest may tap on an item to indicate that the guest is responsible for paying for the item. As another example, a guest may drag and drop or organize items into columns, lists, groups, etc.

In some embodiments, when the first guest pays for the first subset of the items, the mobile payment server 130 may only send the amount paid for (including tax and tip) to the POS or the POS cloud server 150. When the second guest pays for the second subset of the items, the mobile payment server 130 may only send the amount paid for by the second guest (including tax and tip) to the POS or the POS cloud server 150. When the third guest pays for the third subset of the items, if a third guest exists, the mobile payment server 130 may only send the amount paid for by the third guest (including tax and tip) to the POS or the POS cloud server 150.

In some embodiments, when the first guest pays for the first subset of the items, the mobile payment server 130 may send the amount paid for (including tax and tip) and the first subset of items to the POS or the POS cloud server 150. When the second guest pays for the second subset of the items, the mobile payment server 130 may send the amount paid for by the second guest (including tax and tip) and the second subset of items to the POS or the POS cloud server 150. When the third guest pays for the third subset of the items, if a third guest exists, the mobile payment server 130 may send the amount paid for by the third guest (including tax and tip) and the third subset of items to the POS or the POS cloud server 150.

Some embodiments may include a number of steps such as, for example, (1) matching a guest device with a table; (2) retrieving and presenting a unique webpage with a check associated with items ordered at the table; (3) calculating taxes, tip and/or an total check amount or a partial check amount; and/or (4) receiving payment for the check, etc. These steps may or may not occur at the same server, location, or device.

In some embodiments, matching may include associating a guest (e.g., guest) to the check associated with the guest. In some embodiments, for a payment to be made in full or part to a check or other amount payable, the appropriate check and the guest should be matched. For example, if someone wants to pay a check in a restaurant, there are probably multiple checks at the restaurant and it must be determined which one is associated with the guest. There are a number of ways to match a check with a guest.

For example, a guest and check may be matched using the code 120. While a QR code is discussed, any type of code may be used. A QR code (or other identifier element) can be printed on a physical check such as, for example, using printer 125. The QR code may be scanned with one or more cameras, such as, for example, a camera on guest device 110 and/or guest device 111. The QR code can be translated to URL, which points to a webpage that when requested displays a check with information and/or added enhancements (e.g., restaurant logo, background image, server picture, etc.). The URL may be a base URL that may include a query string that together represents and/or includes unique info that identifies the check associated with the code 120. The info identifies a check and when the user device requests the URL it effectively makes a matching to that check. The mobile payment server 130 can use that info to communicate with the POS 105 or POS cloud server 150 to identify the check associated with the guest. The mobile payment server 130 can provide services for the check submitted by the associated URL.

In some embodiments, the URL and/or query string can indicate at least one of the following: a check number, a unique code that represents check and a restaurant, a restaurant name or identifier and table number, a unique code the represents the restaurant a guest's membership number, a unique guest number, a reservation number, any other ID that can be associated with the check, a guest's location in the restaurant, a timestamp or other unique data that can line up with a check, any other data that can indicate the check, etc.

As another example of matching, a code (e.g., a QR code, or other symbol or recognizable visual or language element(s) or character(s) or radio-based identifier like RFID) may be placed on a table or some item on or near or associated with the table or location or order or item ordered or delivered or guest. Once the table has been identified, the corresponding check associated with the table may be identified.

As another example of matching, a guest may sign into an account that can identify them and/or match them to their check, for example an app or website, etc. where information exists that can be correlated to what the guest must be billed in the restaurant or other establishment

As another example of matching, a guest's phone can be triangulated within the restaurant based on video, audio, light, GPS, Bluetooth, Wi-Fi, or other electromagnetic waves to identify a table location. Once the table has been identified, the corresponding check associated with the table may be identified.

As another example of matching, a guest identifier such as a phone number, email address, username or other can be provided to the POS and then a link to the check can be sent to that identifier.

As another example of matching, a guest may go to a specific URL to enter a check number or any other info that can directly or indirectly identify their check.

As another example of matching, a guest may go to a specific URL where a guest can start typing items they ordered, table number, or any other information that can identify their check and it will narrow down to a list of open check(s) with the items they entered. The guest can then click the check that looks like theirs.

As another example of matching, a guest may request a specific or general URL, which could be as simple as going to a specific webpage (e.g., Upngo.com) on a guest device that displays a video (e.g., with a series of screen flashes), an image (e.g., with a code, pattern, color(s), etc.), or play some audio (possibly inaudible to the user). Cameras, microphones, or other sensors in the restaurant may detect the location of the phone or other device accessing that URL by matching the video, image and/or audio to a specific location in the restaurant where the phone or other device is detected. The specific location in the restaurant can then be matched to a check. For example, the location of the guest's phone can be determined to be at Table X, the POS or other data source, can then determine which check is associated with Table X. The POS or the POS cloud server or the mobile payment server can update the specific webpage where the user check be displayed.

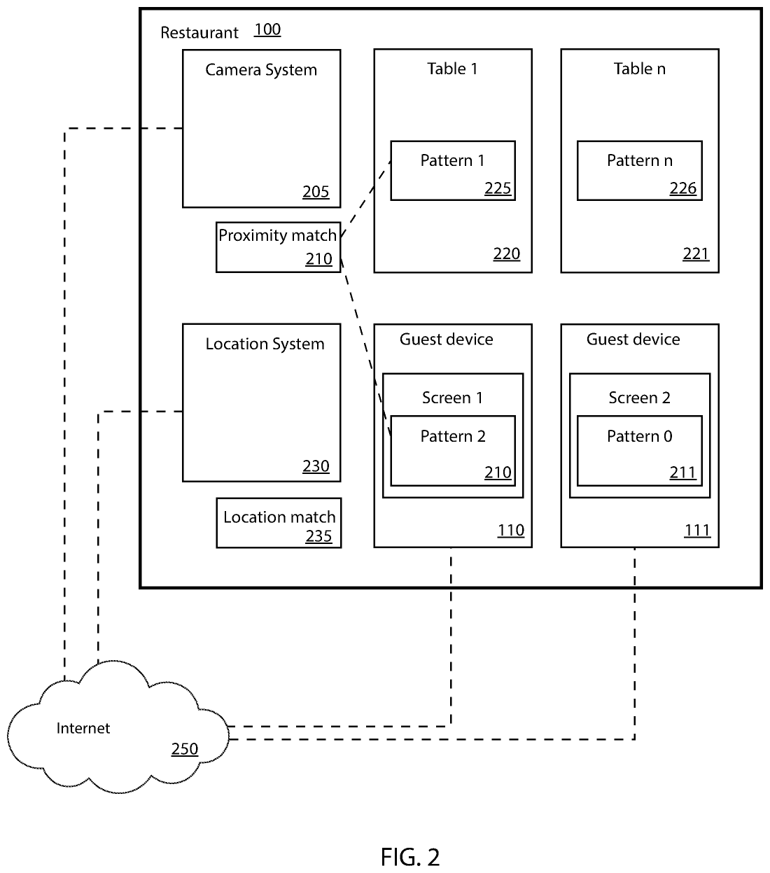

FIG. 2 shows a restaurant that includes a camera system with a plurality of cameras 205 distributed throughout the restaurant 100. One or more of the plurality of cameras 205 may identify a guest upon entering the restaurant 100 such as, for example, using facial recognition software. One or more of the plurality of cameras 205 may track the location of the guest within the restaurant 100.

One or more of the plurality of cameras 205 may identify the table (or bar stool, or position) within the restaurant where the guest ordered goods or services. For example, table 220 and table 221 may be identified by a table pattern 225 or a table pattern 226 located on or near the respective table. The pattern can be specific for a given table (or bar stool or position). The pattern, for example, could include a sticker with a pattern affixed to the table, a pattern printed on the table, or a pattern on an accessory on the table. The pattern may include a pattern inherent to the table, such as, for example, a unique wood grain (or other material grain) of the table or material imperfections of the table, a pattern of scratches, (any of these acting like a fingerprint of the table), or the arrangement of or detection of elements on or around the table. As another example, the pattern could include a weaving pattern in a fabric of a tablecloth or a visual characteristic of the fibers of the tablecloth. As another example, a microchip or electronic element embedded in the tablecloth or table or an item placed on the table that is detected by sensors and used to match the table to the guests and/or their items ordered. As another example, a small light may be placed on the table or on an object placed on the table that emits a light pattern that can be detected by a video camera but cannot be detected by a human such as, for example, at a frequency above 30 Hz. Machine learning algorithms can be employed to learn patterns associated with a specific table.

The plurality of cameras 205 may be able to retrieve data identifying the table based on the table pattern 225 or table pattern 226. In some embodiments, the table pattern 225 and/or the table pattern 226 may include QR codes.

The guest could open a view on the guest device 110 (or guest device 111), such as a website that could display a device pattern 210 on the screen of the guest device 110. The cameras 205 can observe and/or record the device pattern 210. The camera system 205 may be able to match the guest with the guest device 110 with the table 220 by knowing the table pattern 225 and the device pattern 210 on the guest device 110. Similarly, the camera system 205 may be able to match the guest with the guest device 111 with the table 111 by knowing the table pattern 226 and the device pattern 211 on the guest device 111. The system (e.g., the POS, the POS cloud server, the mobile payment server) could visually recognize that a given pattern (or other identifier) on the guest device screen is nearest a given pattern (or other identifier) of a specific table, thus matching the guest to the table. The POS (or POS cloud server or other server) can match the table to the check, and, thus matching the guest to their check. In this way, the guest may be linked to a check without scanning any codes or entering any data.

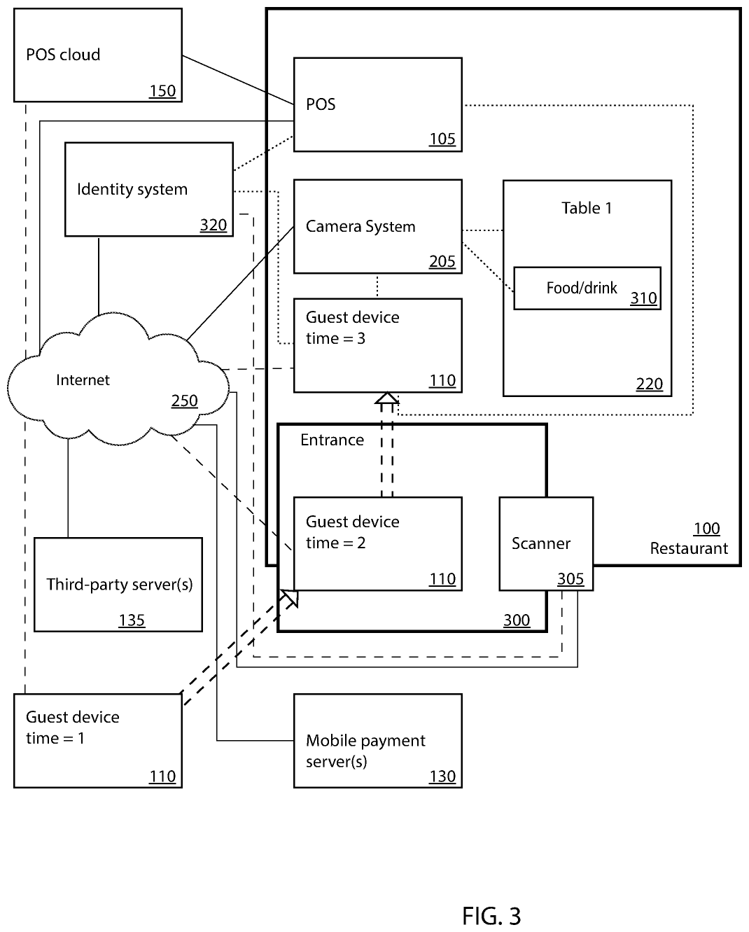

FIG. 3 is block diagram of another example of a matching system according to some embodiments. In this example, it shows the guest device 110 moving from outside the restaurant 100 at time 1, within the entrance 300 of the restaurant 100 at time 2, and inside the restaurant 100 at time 3. At time 1, the guest device 110 is outside the restaurant 100. As the guest moves into the entrance 300 of the restaurant 100, a scanner 305 may be used to identify the guest. For example, the scanner 305 may include a camera that uses facial recognition software to identify the guest's face. As another example, the scanner 305 may scan a code on the screen of the guest device 110. As another example, the scanner 305 may retrieve the MAC address broadcast by the WIFI transceiver on the guest device 110. As another example, the scanner 305 may retrieve a unique Bluetooth identifier broadcast by a Bluetooth transceiver on the guest device 110. In some embodiments, the Bluetooth identifier may include a scan record, a UUID, manufacturer data bytes, service data bytes, advertisement address, etc. The scanner could use any other mechanism to detect and/or identify the guest device, such as any pattern of electromagnetic radiation whether in the visual, audio, radio, or other spectrum, and whether that radiation is emitted and/or reflected by the device. The scanner could also or instead detect the specific guest by anything that could identify the guest as they pass the scanner, whether it is something that is part of the guest and/or part of something carried, on, or attached to the guest. The face of the guest, or other unique identifier of the guest such as their gait, etc. could be matched with this identity upon entering.

As the guest moves from the entrance 300 into the restaurant 100, the cameras 205 can track the guest to a table 220 (or seat, bar stool, etc.). In this example, the identity system 320, can associate the guest with a specific table 220. Once the table is known, the specific guest device 110 can be associated with the proper check. This may be done for more than one guest seated at the table 220. When the check is completed, it may be sent to the guest device 110, as a response to a request originating from the guest device, or sent without a request, of one or more guests at the table.

In some embodiments, the cameras 205 and computer server may also identify the food and/or drink 310 (or goods and/or services) ordered by guests at the pattern 220. A scanning system, for example, may recognize an identifier of items delivered to a table and can use this information to determine the items that belong on the check for the guest.

In some embodiments, the cameras 205 and a computer server may detect how a guest(s) interacts with the goods that were delivered and add a charge to the check that reflects how the user interacted with the goods. For example, if a plate of French fries was delivered to a table with two guests, the system may count 50 French fries present and count that one guest ate 20 of the French fries whereas the other guest ate 30 of the French fries and accordingly apply ⅖ of the cost of the French fries to the first guest, and apply ⅗ of the cost of the French fries to the check of the second guest. The system may also determine that one guest reached for the French fries ten times while the other reached for the French fries five times and apply ⅔ of the cost of the French fries to the first guest and ⅓ to the second guest. The system could also determine which check belongs to which guest at a table. The system may have voice recognition capabilities and create a check for a person based on listening to what they ordered from a server. If the guest device heard the guest ordering, it may send their order to the restaurant POS, which could help create an order and/or associate a check and/or items ordered with a guest device and/or guest.

Retrieving & Presenting.

In some embodiments, retrieving and presenting may include retrieving and presenting check data. In some embodiments, when the appropriate check for the given guest is identified by the mobile payment server 130 and/or the POS cloud server 150, then the contents of that check may be retrieved from the POS 105 and/or the POS cloud server 150. This may, for example, include enhancements with information from the mobile payment server 130. This may also include presenting the check contents to the guest.

For example, from the URL, the system may know where to go to get the check data. This may include, for example, the POS 105, a connection method to that POS or database for that POS, a restaurant name or ID, a check name or ID, etc. This may also include, for example, what enhancements to add (e.g., restaurant logo, background image, server photo, etc.). In some embodiments, these enhancements may be stored in a database and after retrieving check data, these enhancements may be added to create check presentation to guest in their browser.

Calculating.

Calculating may include calculating an amount to be paid by a guest associated with a check. In some embodiments, a guest may not want to pay the full amount due on the check or multiple guests may want to split the check. For example, the guests may want to split the check with other guests. The mobile payment server 130, for example, can assist the guest in calculating how much they should pay. This can be done, for example, by letting each guest pick individual items from the check, then calculating the tax, surcharges, discounts, tip, etc. due for those item(s) only. As another example, this can be done by proration or by knowing taxes or other proportional surcharges per item. This calculation may or may not go back to the POS. Possibly, the POS will know only the partial payments and potentially the breakdown of those amounts due to tax, surcharges, discounts, tip, etc. As another example, a visual or auditory system may detect the goods ordered by each guest and/or detect the goods eaten or how much was eaten by each guest and prepare a check accordingly.

In some embodiments, a guest may pick items or fractions of items (e.g., could be whole check or other fraction of check determined in other ways, like what's unpaid, quantity of guests of total guests, dollar amount, specific items in full or part selected from the check, additional items to be added to the check or prepaid, etc.). For example, taxes, fees, discounts, etc. can be calculated. As another example, a proportional tip can be suggested such as, for example, with a proportional tip calculator (possibly managing total tip due separate from amount due in case people want to pay different proportions of tip than proportion of check, e.g. “Let's split it and I'll pay all the tip.”).

As another example, multiple parties may split a check. For example, the mobile payment server 130 could get data, such as check data, from the POS 105 that includes a list of items on a check, the item prices, and may also include upcharges or adjustments to various items, plus subtotals, taxes or discounts applicable to the whole check or subsets of the check. The mobile payment server 130 could present this to a guest via a browser such as in a phone or tablet. The mobile payment server 130 could provide, for example, a webpage where a guest could select individual items they ordered or wish to pay for, including fractions or subsets of items. The guest could enter something to identify themselves, such as their name or email or phone number or sign into an account that can identify them or something else, or some identifier could be gathered from the phone or some other automatic, random, sequential, or other algorithmic assignment method or based on a prior login or cookie or something else. The mobile payment server 130 could calculate for just the items selected by the guest what the total cost would be including prorated, if applicable, or associated, tax, surcharges, discounts and any other pricing adjustments. Some may apply to the whole check, in which case they may be prorated by the dollar amount of items selected, whereas some might apply to the item selected only, in which case they may be applied in total, or there may be subsets or other rules followed to sum associated charges, taxes, surcharges or other items relevant and to be grouped with only the item(s) and/or their portion(s) selected. It could then present tipping options, for example percentages and their resulting monetary totals to the guest based on totals as described herein, and add them to the total. Then guest can select and submit a payment. Then the mobile payment server 130 can store this data. The mobile payment server 130 can send this data or just a total payment amount including any breakdown, e.g. The subtotal, the tax and the tip to the POS. The POS may keep a tally of the amount of money in these categories and/or total paid to the check, but may not know what these payments represent or who selected them. Meaning that the POS could know $16.50+$3 tip was paid on a check totaling $100+$10 tax, while the POS may not know the identifier of the person or what items, full or partial were selected and what math was conducted to get to that amount paid.

In some embodiments, when the next guest loads the check, the mobile payment server 130 could display the full check and show the payments from the previous guest indicating which items they paid for, their identifier, etc. because the mobile payment server 130 received and stored this information from the previous guest, even though the POS may not have this information and know which items the first payment applied to.

For example, at Restaurant #1, there could be a check #1 in the POS that has multiple food items and drinks on it and/or other items that total a subtotal of $100 plus 10% tax ($10) for a total due of $110. A first guest can load the check (e.g., as described above) and see every item on it and all associated charges. The first guest could enter that their name is Sam. The first guest can select from the items on a check a burger for $10 and a soda for $5 equaling a $15 subtotal, out of a check containing more items, and the check has 10% tax, it could calculate 10% of $15 or $1.50 tax and add it together to get a total due for the burger and soda of $15+$1.50=$16.50. Then the mobile payment server 130 could let the guest pick or enter a tip or tip percentage based on the subtotal or tax. For example, if the guest enters 20% tip on the subtotal, that's 20% of $15 or $3. So then the total amount to pay is $15+$1.50+$3=$19.50. The mobile payment server 130 could save this information and send the payment of $16.50 plus $3 tip to the POS. The mobile payment server 130 could send that payment to the POS without sending information strictly saying this payment was by Sam for a burger and soda (or it could).

A second guest at Restaurant #1 could subsequently load Check #1. The mobile payment server 130 could show them everything on the check, the associated prices, plus any surcharges, discounts, or any other fees, and also show that Sam paid for one burger and one soda and how much money is due in which categories and which items, whole or in fraction, have not specially been paid for. The mobile payment server 130 could get fresh information from the POS that shows indeed nothing has been added or removed from the check and the original payment submitted remains in place. The second guest could enter their name as Bob. The second guest could select a cheese plate that was $20 from the check and indicate that they will pay for half the cheese plate, or $10. Then 10% tax gets added, totaling $1. Then a set of suggested tips based on the pre-tax amount get displayed, e.g. 18% ($1.80), 20% ($2), or 22% ($2.20). The guest could choose one of those or manually enter a percentage or tip dollar amount, e.g. 50% or $5 if they want to tip $5. Then the guest could submit payment of $10 plus $1 tax plus $5 tip totaling $16. The mobile payment server 130 could store all this information. The mobile payment server 130 could submit this payment to the POS. The mobile payment server 130 may or may not submit that this guest is named Bob and that the payment was for half a cheese plate.

In some embodiments, if a guest paid directly with the POS 105 via the server, this could be displayed on any subsequent load of the check on the interactive webpage on the mobile payment server 130 alongside the other guest names and their payments, also indicating how much remains to be paid and which items were specifically paid by whom.

In some embodiments, visual or text or other identifiers representing the guests could be next to the items they paid. Or vice versa, where things paid for are visually associated with who paid how much for them. Like a pie chart of who paid how much of what. These could come from a login, cookie or other gotten from a guest's interaction with the check.

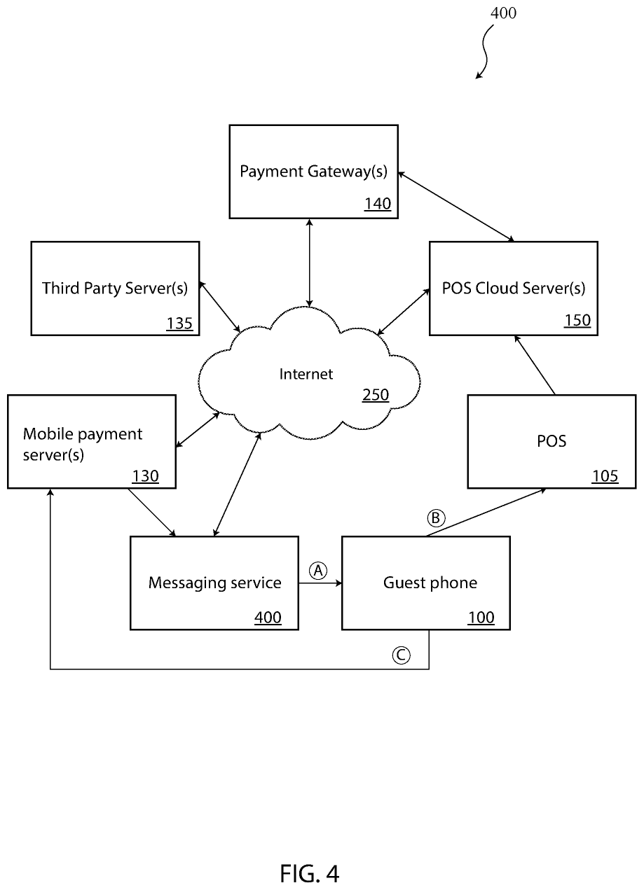

An example check matching system 400 is shown in FIG. 4 according to some embodiments.

In some embodiments, items need not be items customarily in a restaurant. For example, the items could be any charges for any products or services between any parties in any industry or in a non-commercial setting.

In some embodiments, payments may have other details that can enable them to be matched between the mobile payment server 130 and the POS. This could include a card type and portion of the card number, a code associated with a payment, a timestamp, the amount of the payment and its parts, or anything else.

Receiving Payment

In some embodiments, submitting payment may include submitting and tracking payment from the guest to the restaurant. In some embodiments, the guest may submit payment for the amount they choose to pay towards the check.

In some embodiments, payment may be received from guests in any number of ways. For example, a guest may enter credit card info, e.g. number, expiration date, zip code, address, CVC, brand, etc. In some embodiments, payment may be processed with a third-party processor, such as, for example, the mobile payment server 130. In some embodiments, a gift card or other sources of payments, discounts, or monies can be applied. In some embodiments, banking info may be retrieved from customer, such as enough to process ACH or other transfer. In some embodiments, crypto currency info may be received for payment via cryptocurrency. In some embodiments, information for Apple Pay, Google Pay, Samsung Pay, Venmo, PayPal, etc. or other similar services, may be received.

In some embodiments, payment processing may include one or more of the following: put guest's credit card info to restaurant POS or other designated processor for restaurant; submitting a third-party credit card (such as the mobile payment server 130 credit card) to restaurant POS or other designated processor for restaurant; ACH money to restaurant on any timetable; submitting some tender type to restaurant essentially adding fees due to an ongoing tab to be reconciliated/paid later, e.g. by the mobile payment server 130 or guest; submitting any other means of payment to restaurant; and/or submitting multiple payments including the above or other types of payments.

The check matching system 400 can submit a credit card number and any other card data, such as expiration date, ccv, etc. to the restaurant POS, POS cloud server, or payment gateway and indicate an amount to charge on that card to pay for a check. The check number may be indicated in this request. If the system is paying a gateway that is external to the restaurant POS, the system could subsequently note the payment in the POS by submitting a tender payment.

This check matching system 400 can intermediate this processing. For example, the system could accept payment from the guest and mobile payment server can pay the restaurant. The amount this system collects could be the same amount or a different amount than the system pays the restaurant POS or gateway. The method used to pay mobile payment server could be different than the method mobile payment server uses to pay the restaurant.

For example, a guest could pay a check via the mobile payment server via Apple Pay. The mobile payment server could pay the restaurant the same amount using a credit card. The credit card may belong or be associated with the mobile payment server rather than the guest.

As another example, the guest could be given an option to add more payment to their check, i.e. the guest could elect, by prompt from the system or not, to add extra payment(s) for other reason(s). For instance, the guest could elect to “tip” the restaurant, or donate to the restaurant or to another cause. The system could collect this amount via its own processor. The system could then pay the restaurant POS and/or gateway the amount due for the check, including a server tip, but minus the restaurant tip or donation to the restaurant or other entity or entities. This lets the system effectively add items to the check and collect payment for those items without those items having to be added in the POS. (Some POS systems will not allow a payment for any amount greater than due. This process creates a way for the system to circumvent that limitation and collect more than is due for the check.) The system can store these amounts in its database or via other methods and calculate disbursements for additional items (restaurant tips, donations, sales of other items, which could be merchandise, gift cards, pre-ordered items, events, additional food, like a desert, food to go, etc.) The system can send any information or funds, minus any processing or handling fees, to any other system or account.

The check matching system 400 may enable payment options not possible with the restaurant's POS or gateway. For example, this system can use 3D Secure to authenticate the guest along with their payment. Perhaps the restaurant's POS or gateway may not support 3D Secure. However, the mobile payment server can provide a gateway that supports 3D Secure and accept a 3D Secure payment. The mobile payment server could send that payment (adjusted upward or downward if desired or necessary) to the restaurant's POS and/or gateway in a different way, such as not using 3D Secure, consistent with the form of payment or authentication or other technological means supported by the restaurant's POS or gateway.

Rules may be established that route the payment through different systems or sets of rules. For example, since 3D Secure may entail an additional processing cost, a rule could be created to only use 3D Secure for transactions that meet certain requirements, for example a rule could be that if a payment is $50 or more, but not if otherwise, send it through this system to process with 3D Secure and use separate mechanism to send payment to the restaurant. Any criteria could be established. For example, credit cards could be handled one way, whereas Apple Pay or Venmo could be handled another way. This Advanced Payments system effectively allows translation of payment methods and addition of purchasing, ordering, and payment systems that may not be supported by the restaurant's POS and/or gateway or other systems.

In some embodiments, payment processing may include error correcting. For example, the mobile payment server 130 can submit a payment to the POS, then afterwards check the balance on the check from the POS. If the mobile payment server 130 detects that the payment wasn't successful, then it could resubmit according to any schedule. As another example, if the mobile payment server 130 tries to submit a payment to the POS and the POS reports that it can't accept the payment for any reason, then the mobile payment server 130 could try to resubmit the payment according to any time schedule or criteria or pre-programmed adjustments, for example it could alter the amount or the payment method, such as the credit card used, to one that works. Optionally, available credit cards or other payment methods could be stored along with an order to use them in. As another example, the mobile payment server 130 can store and match any information to check POS for payments on a check and see if it matches payments submitted.

The system could collect payment from the guest at any time relative to when the system makes payment to the restaurant POS and/or gateway. For example, the system could collect authorization of the payment from the guest, then submit payment to the restaurant, then settle the guest's payment. As another example, the system could authorize and settle payment with the guest, then pay the restaurant's POS or gateway at a later time. If the restaurant POS or gateway is unavailable or unable to accept payment, the system could retry later and/or the system could adjust the payment to make it go through or get cancelled in whole or in part. For example, if the system collected $50.01 from the guest but then when it tries to pay the restaurant, only $50.00 is due, the system could pay the restaurant $50.00 and make any decision with regard to what to do with the remaining $0.01. The system could keep the $0.01, or the system could refund the $0.01 to the guest, or the system could adjust the guest's payment down to be $0.01, or the system could apply the $0.01 to some other account, such as a balance maintained for the guest or other entity. The guest could be provided with the option to accept a change in their payment amount, or it could happen automatically according to rules established in the system.

Any data about any transaction may be sent to any system.

Extended services may be provided that leverage data related to the payment. At any point in the process, for example, information available may be leveraged to provide more customized information access and functionality. For example, after paying, the guest can get an email or text receipt of that payment.

In some embodiments, extended services may include: sending an email or text receipt of the payment to the guest, allow the guest to send feedback/ratings pertaining to this payment, allow the customer to send ratings, photos, other comments on specific items, etc.

In some embodiments, extended services may include adding items to the check may be provided. For example, the system may obtain and present a list of items and associated metadata like price, optional modifications, and picture that the guest may choose to add to their check. This list, for example, may be provided by the POS and/or other sources. In some embodiments, enhancements may be added from the mobile payment server 130 or other sources. For example, the POS may be queried for a category of items (and their prices and optional modifications and their prices) like deserts. The POS may not contain pictures of deserts. The mobile payment server 130 may contain pictures of the deserts and match them to the items, modifications and prices supplied by the POS. For example, the POS may list an item such as apple pie for $8 and an optional modification of adding ice cream for $2. The mobile payment server 130 will add a picture of the apple pie and the ice cream and provide the images along with item name, price and modification to the guest.

In some embodiments, ordering choices from a guest may be sent to the POS. In some embodiments, ordered items may be added to any of the steps of any portion of the process.

In some embodiments, a guest may buy and/or use a gift cards as part of the payment system. For example, a guest may buy a gift card (or adds to a stored value account). The money associated with the gift card may go into a pool or a dedicated account. In some embodiments, if the guest first paid a check from a given restaurant, that restaurant may be credited an amount, such as 1% for that gift card purchase. In some embodiments, when the gift card is to be spent as a means to pay an check using the mobile payment server 130, a card or ACH or other payment transfer mechanism will pay that check from the funds in the pool or dedicated account. In some embodiments, the restaurant where the gift card was used may be charged a service fee by the mobile payment server 130, such as 1% of the gift card spend on that check. In some embodiments, the mobile payment server 130 may make money, such as interest or unused gift card funds from the pool or dedicated account.

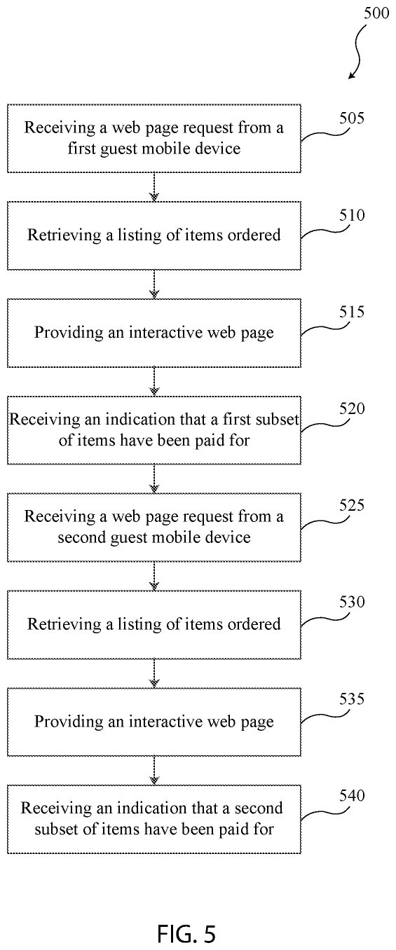

FIG. 5 is a flowchart of a process 500 for splitting a check at a restaurant according to some embodiments. The various blocks of process 500 may occur in any order, any block may be removed or replaced, and/or additional blocks may be added.

Process 500 begins at block 505. At block 505 a webpage request from a first guest mobile device may be received at a server such as, for example, the mobile payment server 130 or the one or more third-party servers 135. The webpage request, for example, may include check data that specifies a specific check at a specific restaurant.

At block 510 a listing of items ordered and a cost for each item ordered based on the check data can be retrieved. The listing of items ordered may include all the items ordered at a given table or on a given tab at the restaurant. The listing of items ordered and/or the cost for each item may be retrieved from either or both the POS 105 and the POS cloud server 150.

A block 515, an interactive webpage can be created and sent to the first guest mobile device. The interactive webpage, for example, may include a listing of items ordered and the cost of the items ordered. As another example, the interactive webpage may calculate and/or display a total amount due that may be calculated from the first subset of the listing of items. As another example, the interactive webpage may calculate and display taxes due calculated from the first subset of the listing of items. As another example, the interactive webpage may include a data entry portion that allows the first guest to provide a tip amount. As another example, the interactive webpage may include one or more proposed tip amounts based on one or more percentages of the total amount of first subset of the listing of items. As another example, the interactive webpage may include graphics associated with the specific restaurant.

At block 520 an indication may be received from the first guest mobile device at the mobile payment server 130 and/or the one or more third-party servers 135. The indication may indicate a first subset of the listing of items selected by the first guest and paid for by the first guest.

At block 525 a webpage request from a second guest mobile device may be received at the server such as, for example, the mobile payment server 130 or the one or more third-party servers 135. The webpage request, for example, may include check data that specifies a specific check at a specific restaurant. The webpage request may, for example, be exactly or substantially similar as the webpage request sent from the first guest mobile device. As another example, the webpage request may be the same URL.

At block 530 a listing of items ordered and a cost for each item ordered based on the check data can be retrieved. The listing of items ordered may include all the items ordered at a given table or on a given tab at the restaurant. The listing of items ordered and/or the cost for each item may be retrieved from memory at the server or from either or both the POS 105 and the POS cloud server 150.

A block 535, an interactive webpage can be created and sent to the second guest mobile device. The interactive webpage may be substantially the same as the interactive webpage sent to the first guest mobile device. The interactive webpage sent to the second guest mobile device may include an indication that the first subset of the listing of items has been paid for. The indication that the first subset of items has been paid for may include one or more of the following: displaying the first subset of the listing of items in a different font, displaying the first subset of the listing of items in a different color, displaying the first subset of the listing of items in a different transparency, displaying the first subset of the listing of items without a check box or radial button, displaying the first subset of the listing of items with a strikethrough, displaying the first subset of the listing of items with the name of the first individual, and/or displaying the first subset of the listing of items in a different section than the other remaining items.

The interactive webpage, for example, may include a listing of items ordered and the cost of the items ordered. As another example, the interactive webpage may calculate and/or display a total amount due that may be calculated from the first subset of the listing of items. As another example, the interactive webpage may calculate and display taxes due calculated from the first subset of the listing of items. As another example, the interactive webpage may include a data entry portion that allows the first guest to provide a tip amount. As another example, the interactive webpage may include one or more proposed tip amounts based on one or more percentages of the total amount of first subset of the listing of items. As another example, the interactive webpage may include graphics associated with the specific restaurant.

At block 540 an indication may be received from the second guest mobile device at the server or the mobile payment server 130 and/or the one or more third-party servers 135. The indication may indicate a second subset of the listing of items selected by the second guest and paid for by the second guest. The second subset being mutually exclusive with the first subset.

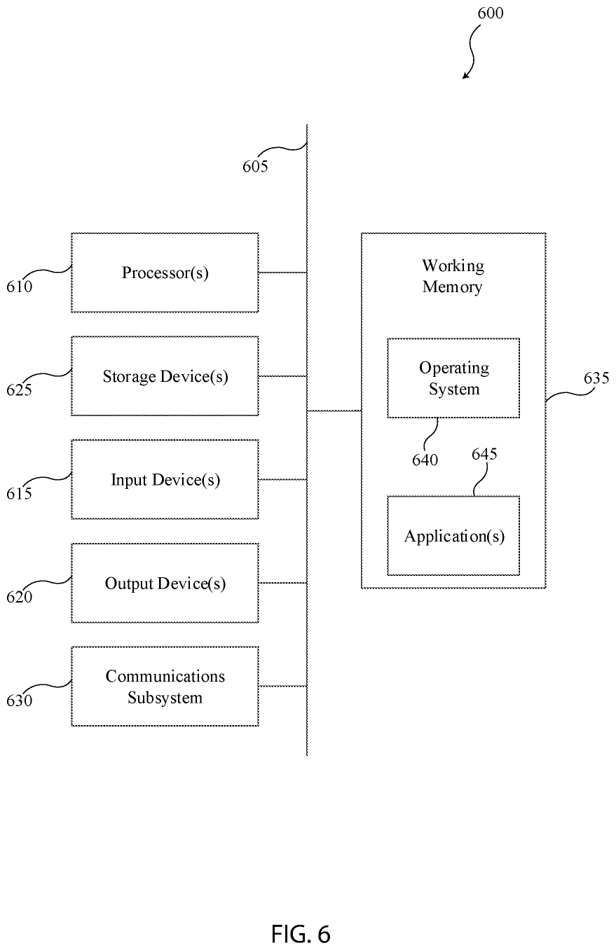

The computational system 600, shown in FIG. 6 can be used to perform any of the embodiments of the invention. As another example, computational system 600 can be used perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
receiving at a remote payment server a webpage request from a first guest mobile device, the webpage request including check data that specifies a specific check at a specific restaurant;
retrieving a listing of items ordered and a cost for each item ordered based on the check data;
providing an interactive webpage to the first guest mobile device, the interactive webpage includes a listing of items ordered and the cost of the items ordered; and
receiving an indication from the first guest mobile device that indicates a first subset of the listing of items selected by the first guest and paid for by the first guest.

2. The method according to claim 1, further comprising:
receiving a webpage request from a second guest mobile device, the webpage request including the check data that specifies the specific check at the specific restaurant;
retrieving the listing of items ordered and the cost for each item ordered based on the check data;
providing an interactive webpage to the second guest mobile device that lists the listing of items ordered and the cost including an indication that the first subset of the listing of items have been paid for; and
receiving an indication from the second guest mobile device that indicates a second subset of the listing of items selected by the second guest and paid for by the second guest.

3. The method according to claim 1, wherein the interactive webpage calculates and displays a total amount due that is calculated from the first subset of the listing of items.

4. The method according to claim 1, wherein the interactive webpage calculates and displays taxes due calculated from the first subset of the listing of items.

5. The method according to claim 1, wherein the interactive webpage includes a data entry portion that allows the first guest to provide a tip amount.

6. The method according to claim 1, wherein the interactive webpage includes one or more proposed tip amounts based on one or more percentages of the total amount of first subset of the listing of items.

7. The method according to claim 1, wherein the interactive webpage includes graphics associated with the specific restaurant.

8. The method according to claim 2, wherein the interactive webpage provides an indication that the first subset of the listing of items has been paid for.

9. The method according to claim 8, wherein the indication that the first subset of items has been paid for includes displaying the first subset of the listing of items in a different font, displaying the first subset of the listing of items in a different color, displaying the first subset of the listing of items in a different transparency, displaying the first subset of the listing of items without a check box or radial button, displaying the first subset of the listing of items with a strikethrough, displaying the first subset of the listing of items with the name of the first individual, and/or displaying the first subset of the listing of items in a different section than the other remaining items.

10. The method according to claim 2, wherein the interactive webpage calculates and displays a total amount due that is calculated from the second subset of the listing of items.

11. The method according to claim 2, wherein the interactive webpage calculates and displays taxes due calculated from the second subset of the listing of items.

12. The method according to claim 2, wherein the interactive webpage includes a data entry portion that allows the second guest to provide a tip amount.

13. The method according to claim 2, wherein the interactive webpage includes one or more proposed tip amounts based on one or more percentages of the total amount of second subset of the listing of items.

14. A method comprising:
receiving at a remote payment server a first webpage request from a first guest mobile device, the first webpage request including check data that specifies a specific check at a specific restaurant;
retrieving a listing of items ordered and a cost for each item ordered based on the check data;
providing an interactive webpage to the first guest mobile device, the interactive webpage includes a listing of items ordered and the cost of the items ordered; and
receiving an indication from the first guest mobile device that indicates a first subset of the listing of items selected by the first guest and paid for by the first guest.
receiving at the remote payment server a second webpage request from a second guest mobile device, the second webpage request including the check data that specifies the specific check at the specific restaurant;
retrieving the listing of items ordered and the cost for each item ordered based on the check data;
providing an interactive webpage to the second guest mobile device that lists the listing of items ordered and the cost including an indication that the first subset of the listing of items have been paid for; and
receiving an indication from the second guest mobile device that indicates a second subset of the listing of items selected by the second guest and paid for by the second guest.

15. A method comprising:
receiving a request for a check from a mobile device;
identifying the location of the mobile device within a restaurant;
associating the location of a mobile device with a restaurant table;
determining one or more menu items ordered at the restaurant table;
calculating a total check amount based on the one or more menu items ordered;
calculating taxes owed based on the one or more menu items ordered;
creating a unique webpage with the one or more menu items, the sales price of the one or more menu items, the taxes owed, and the total check amount, the unique webpage including a payment method; and
receiving payment information from the mobile device for at least a subset of the one or more menu items.

16. The method according to claim 15, wherein the location of the mobile is identified by sending an image, video, or audio that is meant to be displayed or played on the mobile device.

17. The method according to claim 15, wherein the location of the mobile device is identified using a plurality of cameras disposed throughout the restaurant.

18. The method according to claim 17, wherein the location of the mobile device is identified further comprises pattern matching restaurant features near the mobile device and pattern matching images displayed on the mobile device.

19. The method according to claim 17, wherein determining one or more menu items ordered at the restaurant table includes sending a request to POS for menu items associated with the restaurant table.

20. The method according to claim 2, wherein the unique webpage allows the user to enter a tip amount and recalculates the total check amount.
